(19) United States
(12) Patent Application Publication
(10) Pub. No.: US 2022/0210318 A1
(43) Pub. Date: Jun. 30, 2022

(54) COMPOSITION METHOD AND SYSTEM OF PHOTOGRAPHING DEVICE, AND STORAGE MEDIUM

(71) Applicant: SZ DJI TECHNOLOGY CO., LTD., Shenzhen (CN)

(72) Inventor: Xuyang FENG, Shenzhen (CN)

(73) Assignee: SZ DJI TECHNOLOGY CO., LTD., Shenzhen (CN)

(21) Appl. No.: 17/695,829

(22) Filed: Mar. 16, 2022

Related U.S. Application Data
(63) Continuation of application No. PCT/CN2019/108634, filed on Sep. 27, 2019.

(51) Int. Cl. H04N 5/232; G06T 7/73; G06V 40/16; G06V 40/18

(52) U.S. Cl. CPC H04N 5/23219; G06T 7/75; H04N 5/23299; G06V 40/197; G06V 40/171

(57) ABSTRACT

A composition method and system of a photographing device, and a storage medium are provided. The composition method may include obtaining a composition factor of a target in a image currently photographed by a photographing device, matching the composition factor of the target with a model composition factor in a composition strategy, and acquiring current posture of the photographing device and adjusting or maintaining the current posture of the photographing device based upon result of the matching.

### CROSS REFERENCE TO RELATED APPLICATION

The present application is a continuation of International Application No. PCT/CN2019/108634, filed Sep. 27, 2019, the entire contents of which being incorporated herein by reference in its entirety.

### TECHNICAL FIELD

The present disclosure relates to the field of photography technology, and particularly relates to a composition method, system of a photographing device, and a storage medium.

### BACKGROUND

The gimbal, especially the handheld gimbal, is an important helper for users to take selfies, photograph, and video. When a user uses a handheld gimbal to take selfies, photograph, or video, the user generally extends one or both hands to the front to increase the distance from a photographing device to his or her face so as to expand the viewing range.

### SUMMARY

The present disclosure provides a composition method of a photographing device, a composition system of a photographing device, and a storage medium.

According to a first aspect of the present disclosure, a composition method of a photographing device is provided. The photographing composition method may include:

acquiring a composition factor of a target in an image currently photographed by a photographing device;

matching the composition factor of the target with a model composition factor in a composition strategy; and

acquiring current posture of the photographing device, and adjusting or maintaining the current posture of the photographing device based upon matching result.

According to a second aspect of the present disclosure, a composition system for a photographing device is provided. The composition system may include a memory and a processor. The memory is configured to store a computer program therein; the processor is configured to execute the computer program stored in the memory and, when executing the computer program, configured to:

acquire a composition factor of a target in an image currently photographed by a photographing device;

match the composition factor of the target with a model composition factor in a composition strategy; and

acquire current posture of the photographing device, and adjust or maintain the current posture of the photographing device based upon matching result.

According to a third aspect of the present disclosure, a computer-readable storage medium having stored a computer program therein is provided. When executed by a processor, the computer program causes the processor to implement the composition method of the photographing device described above.

Thus, embodiments of the present disclosure provide a composition method, system, and storage medium for a photographing device, which may match a composition factor of a target in a currently photographed image of the photographing device with a model composition factor in a composition strategy; and adjust or maintain current posture of the photographing device based upon matching result. As the current posture of the photographing device is adjusted or maintained based upon the matching result between the composition factor of the target in the currently photographed image and the model composition factor in the composition strategy, in this way, the composition of the photographed image can be automatically adjusted to avoid interfering with the photographed content, which makes the photographing process coherent, thereby enhancing the user experience, and it can also provide technical support for further flexibly adjusting the composition of the photographed image according to different needs of a user.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic flowchart of a composition method of a photographing device according to some embodiments of the present disclosure.

FIG. 2 illustrates a schematic diagram of using a 3D human face model to set a composition strategy in a composition method of a photographing device according to some embodiments of the present disclosure.

FIG. 3 illustrates a schematic diagram of a face orientation in a horizontal direction in a composition method of a photographing device according to some embodiments of the present disclosure.

FIG. 4 illustrates a schematic diagram of an image after the face orientation is adjusted in a horizontal direction in an application of a composition method of a photographing device according to some embodiments of the present disclosure.

FIG. 5 illustrates a schematic diagram of a face orientation in a vertical downward direction in a composition method of a photographing device according to some embodiments of the present disclosure.

FIG. 6 illustrates a schematic diagram of a face orientation in a vertical upward direction in a composition method of a photographing device according to some embodiments of the present disclosure.

FIG. 7 illustrates a schematic diagram of an image after a face orientation is adjusted in a vertical upward direction in an application of a composition method of a photographing device according to some embodiments of the present disclosure.

FIG. 8 illustrates a schematic flowchart of a composition method of a photographing device according to some embodiments of the present disclosure.

FIG. 9 illustrates a schematic structural diagram of a composition system of a photographing device according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, some components/elements can also be disassembled, combined or partially combined; therefore, the actual arrangement may be changed or modified according to actual conditions. In the case of no conflict, the components, elements, operations/steps and other features disclosed in the embodiments may be combined with each other.

When shooting or photographing with a handheld gimbal, a user usually stretches his or her hand to the front to increase the distance from a photographing device to the face so as to expand the viewing range. However, at this moment, it is difficult for the user to manipulate the photographing device to compose a picture, especially when the composition strategy needs to be changed during the photographing process.

The existing handheld gimbal has a target tracking function, which can continuously keep the target in a fixed position of the picture (such as the center of the picture). However, after the target tracking starts, the target position remains unchanged. If the user wants to adjust the composition, the user needs to manually manipulate it, which will easily interfere with the photographed content and make the photographing process inconsistent.

Some embodiments of the present disclosure are directed to match a composition factor of a target in an image currently photographed by a photographing device with a model composition factor in a composition strategy; and adjust or maintain current posture of the photographing device based upon the matching result. Since the current posture of the photographing device is adjusted or maintained based upon the matching result between the composition factor of the target in the image currently photographed and the model composition factor in the composition strategy, in this way, the composition of the photographed image can be automatically adjusted, thereby avoiding interference with the photographed content and making the photographing process coherent, which improves user experience. It can also provide technical support for further adjusting flexibly the composition of the photographed image according to different needs of the user.

Some embodiments of the present disclosure may be applied to various photographing scenarios with a photographing device that need to automatically adjust a composition. For example, some embodiments of the present disclosure may be applied in a general photographing scene with a photographing device (for example, a digital camera, a mobile device equipped with a camera module, etc.), and may also be applied to photograph scenes from a movable platform. The movable platform refers to various platforms that can move automatically or move under controlled conditions such as a gimbal (for example, a gimbal camera, etc.), an unmanned aerial vehicle, a vehicle, an unmanned vehicle, a ground robot, etc.

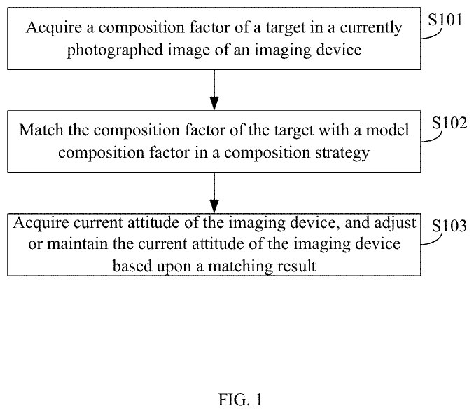

Please refer to FIG. 1. FIG. 1 illustrates a schematic flowchart of a composition method of a photographing device according to some embodiments of the present disclosure. The composition method of the photographing device may include steps S101 to S103.

Step S101 may include acquiring a composition factor of a target in an image currently photographed by a photographing device.

The term “composition” used herein in the present disclosure refers to a photographic composition, that is, a layout, structure, and content of a photographed image; its specific meaning is to form a coordinated and complete photographed image (which can be understood as an image reflecting needs of a user) according to the requirements of the subject and theme (which can be understood as the needs of the user). Simplicity, diversity, unity, and balance are the basic requirements for the photographic composition.

The term “target” used herein in the present disclosure refers to a theme of a composition. In short, it may be an object that a user wants to focus on, such as: a person, an animal, a plant, a flower, a building, and so on. A composition factor used herein refers to a condition, a factor, or an element associated with the target that determines the composition. For example, when the target is a person, the composition factor may be a person's face orientation, a person's facial expression, person's eyes, a person's posture, and so on. For another example, when the target is an animal, the composition factor may be an animal's posture, an animal's facial expression, and so on.

When composing a picture, it is first necessary to obtain the composition factor of the target in the image currently photographed by the photographing device.

Step S102 may include matching the composition factor of the target with a model composition factor in a composition strategy.

The term “composition strategy” used herein refers to specific requirements among layout, structure, and content of a photographed image when composing a picture. Simply put, the composition strategy may include a composition factor, layout and structure between a theme and a background, content of the theme and the background, and so on. In the present disclosure, the composition strategy also includes various composition strategies that meet the needs of users.

A model composition factor in the composition strategy is a composition factor that meets the needs of a user. Matching the composition factor of the target with the model composition factor in the composition strategy can determine whether the composition factor of the target matches a composition factor that meets the needs of the user, thereby providing a basis for subsequent composition.

In one embodiment, the model composition factor in the composition strategy may be a specific orientation of a person's face, a specific expression of a person's face, a specific state of person's eyes, etc., or a specific expression of an animal's face or a specific posture of an animal, and so on.

In one embodiment, the composition factor of the target may be, for example, that a person has one eye open and one eye half-closed. The model composition factor in the composition strategy may be that a model character has one eye open and one eye closed. In another embodiment, the composition factor of the target may be that a face orientation of a person is horizontal, and the model composition factor in the composition strategy may be that a face orientation of a model character is horizontal.

Step S103 may include acquiring current posture of the photographing device, and adjusting or maintaining the current posture of the photographing device based upon the matching result.

In the present disclosure, the matching result may be defined in detail according to needs of a user, which is not limited herein. If the current posture of the photographing device needs to be adjusted, how to adjust the current posture of the photographing device can be defined in detail according to the needs of the user, which is not limited herein. In this way, the application scope of the method in some embodiments of the present disclosure can be expanded, and technical support can be provided for flexibly adjusting a composition of a photographed image according to the different needs of the user.

For example, the composition factor of the target may be that a person has one eye open and one eye half closed. The model composition factor in the composition strategy is that a model character has one eye open and one eye closed. It may be considered that the composition factor of the target matches, does not match, or partially matches the model composition factor in the composition strategy. The key to determining the matching result lies in that the achieved effect meets the needs of the user.

Therefore, some embodiments of the present disclosure match the composition factor of the target in the image currently photographed by the photographing device with the model composition factor in the composition strategy and adjust or maintain the current posture of the photographing device based upon the matching result. Since the current posture of the photographing device is adjusted or maintained based upon the matching result between the composition factor of the target of the image currently photographed by the photographing device and the model composition factor in the composition strategy, in this way, the composition of the photographed image can be automatically adjusted, thereby avoiding interference with the photographed content, making the photographing process coherent, and improving the user experience. It can also provide technical support for further flexibly adjusting a composition of a photographed image according to the different needs of users.

Optionally, if the composition strategy has been acquired in advance, the composition factor of the target may be directly matched with the model composition factor in the composition strategy. If the composition strategy is not acquired in advance, before step S102, the method may further include acquiring the composition strategy. Optionally, an implementation method commonly used for acquiring the composition strategy is to acquire a preset composition strategy. That is, before acquiring the composition strategy, it may also include: setting the composition strategy.

In real life, people or animals that are alive and move freely may usually show richer and changeable themes. A wide range of users pay more attention to these living and free-moving persons or animals, especially faces that can intuitively show various thoughts and feelings of persons or animals. Therefore, it is common and useful to set a preset face orientation of the composition strategy.

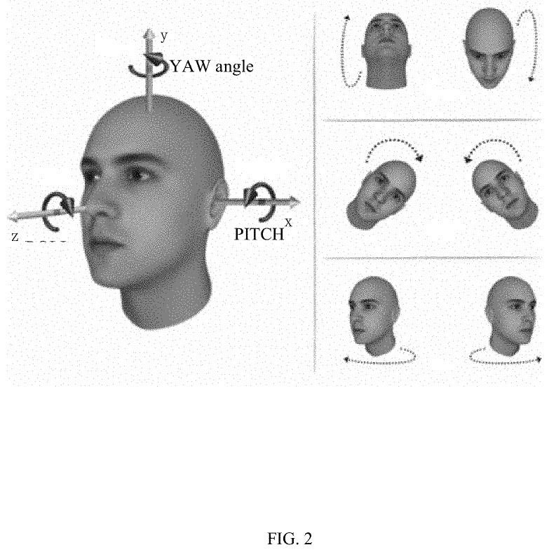

The preset face orientation of the composition strategy may be set in several unlimiting ways. For example, in some embodiments, the preset face orientation of the composition strategy may be directly set, for example, as a tilt angle value of a person's face. The face orientation of the person may be determined based upon the tilt angle value of the person's face. In some embodiments, a face orientation in a known image is set as the preset face orientation of the composition strategy, for example, by loading a photo of a user herself or others in an album through historical photos, selecting a face of a person the user wants to imitate, using an algorithm to automatically identify a face orientation of the person and setting it as the preset face orientation. In some embodiments, a current face orientation of a freely rotatable 3D face model may be set as the preset face orientation of the composition strategy, for example, as shown in FIG. 2. FIG. 2 illustrates a schematic diagram of using a 3D human face model to set a composition strategy in the composition method of the photographing device according to some embodiments of the present disclosure. A freely rotatable 3D face model is provided for user operation. When the user poses the face model to a suitable angle, the user may set it as the preset face orientation. In some embodiments, a face orientation corresponding to a selected face orientation category may be set as the preset face orientation of the composition strategy. The face orientation category may include one or more of a head-down, a head-up, a tilted-head, and a side face.

In certain embodiments, for example, during taking a selfie, a flexible automatic composition strategy is very important. The face (i.e., the face of the target person) is a very important element in the composition, and it is very natural to find the clues of the composition from the face. The face orientation should be consistent with the composition direction. Thus, the face orientation may be selected as a main reference factor to formulate the composition strategy.

In some embodiments, the composition strategy may also be obtained by voice, that is, receiving voice information and recognizing the composition strategy from the voice information. The voice recognition technology and/or the natural language processing technology may be used to understand voice information of a user and recognize the composition strategy, and then the corresponding composition operation is performed. For example, when a reporter is photographing a live broadcast at the interview site, when the reporter mentions “Notre Dame de Paris is behind me on the left,” the photographed image can be automatically swung to the reporter's left to provide a broader photographing angle of view for the target in the topic.

The following will use a face-related factor as a composition factor as an example to illustrate the composition method in detail according to some embodiments of the present disclosure.

The model composition factor may include a factor related to a face of a target, and the composition factor of the target may include a factor related to a face of the target. In some embodiments, the target may usually include a target person or a target animal.

Therefore, step S101 may include acquiring a face orientation of a target in an image currently photographed by a photographing device. In some embodiments, the target may be a target person. When there are two or more persons in the shot image, it is necessary to determine the target person. The target person may be one or more than one person. In some embodiment, the target may also be a target animal such as various pets.

Various methods may be employed for acquiring the face orientation, which are not limited in the present disclosure. For example, in some embodiments, image information of a face is used to estimate the face orientation. That is, acquiring the face orientation of the target in the image currently photographed by the photographing device in step S101 may include estimating the face orientation of the target based upon image information of the face of the target. To simplify the complexity of the estimation, the face orientation of the target may be estimated based upon an image key point of the face of the target. The image key point may include one or more of an image key point of a mouth, an image key point of an eye, an image key point of a nose, or an image key point of an eyebrow.

In some embodiments, the composition factor of the target taking the face orientation of the target as an example, step S102 may include matching the face orientation of the target with a preset face orientation in a composition strategy.

In some embodiments, in step S103, adjusting or maintaining current posture of the photographing device based upon the matching result may include: if the face orientation of the target partially matches the preset face orientation in the composition strategy, adjusting the current posture of the photographing device so that a composition direction of an adjusted photographed image matches a composition direction corresponding to the preset face orientation in the composition strategy; and if the face orientation of the target exactly matches the preset face orientation in the composition strategy, maintaining the current posture of the photographing device. The target may be a target person or a target animal.

The following takes the face orientation of the target as an example to describe more implementation details of three unlimiting application scenarios of step S102 and step S103.

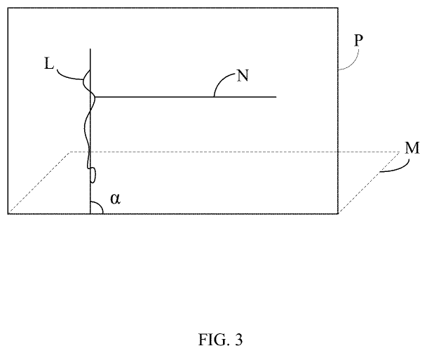

Referring to FIG. 3, FIG. 3 illustrates a schematic diagram of a face orientation in a horizontal direction in the composition method of the photographing device according to some embodiments of the present disclosure. As shown in FIG. 3, P represents a display screen, for example, a display screen of the photographing device. A first target angle α is an angle between a face plane L formed by the face of the target and a reference datum plane M, and a second target angle β is an angle between an eyeball direction N of the target and the reference datum plane M. The reference datum plane M is a horizontal plane parallel to the ground plane. When the second target angle β is 0° (theoretical value, there is a deviation range when evaluating the second target angle β, the deviation range is set according to actual application; β is 0° and not shown in the figure), it means that the target's eyeball is looking straight ahead, and the eyeball direction N is parallel to the reference datum plane M. The face plane L is perpendicular to the reference datum plane M, i.e. the first target angle α is 90° (theoretical value, there is a deviation range when evaluating the first target angle α, the deviation range is set according to actual application). At this time, the face orientation of the target is considered to be horizontal.

Optionally, step S102 may include: if the first target angle is within a preset vertical angle range of the composition strategy (i.e., within a vertical deviation range, set according to specific practical application) or the second target angle is within a preset parallel angle range of the composition strategy (i.e., within a parallel deviation range, set according to specific actual application), determining that the face orientation of the target matches the preset face orientation with a horizontal orientation in the composition strategy.

Optionally, step S103 may include, when the face orientation of the target matches the preset face orientation with the horizontal orientation in the composition strategy, adjusting the current posture of the photographing device so that a composition direction of an adjusted photographed image is horizontal, and a position and proportion of a background in the adjusted photographed image match the face orientation of the target.

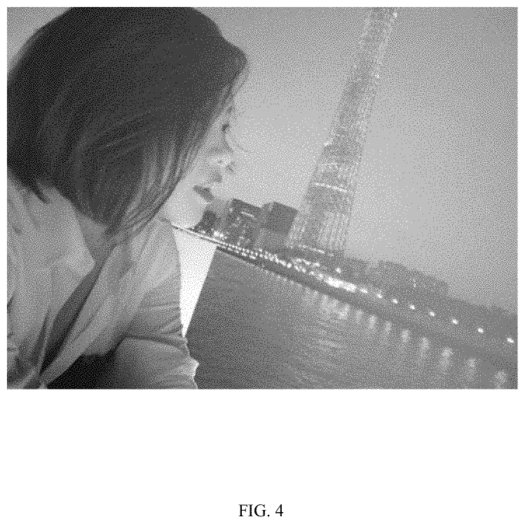

FIG. 4 illustrates a schematic diagram of an image after the face orientation is adjusted in the horizontal direction in an application of the composition method of the photographing device according to some embodiments of the present disclosure. As shown in FIG. 4, the face orientation of the target person in the image is horizontal. After adjustment, the target person is located at the left edge of the image, thereby leaving more space in the direction of the face orientation of the target person to display the background, i.e., river, streetlight across the river, TV tower across the river, other buildings on the other side of the river and other backgrounds.

Referring to FIG. 5, FIG. 5 illustrates a schematic diagram of a face orientation in a vertical downward direction in the composition method of the photographing device according to some embodiments of the present disclosure. As shown in FIG. 5, P represents a display screen, for example, a display screen of the photographing device. A first target angle α is an angle between a face plane L formed by the face of the target and a reference datum plane M. A second target angle β is an angle between an eyeball direction N of the target and the reference datum plane M. The reference datum plane M is a horizontal plane parallel to the ground plane. When the second target angle β is a negative acute angle β1 (the angle above the reference datum plane M is a positive angle, below the reference datum plane M is a negative angle) or a positive obtuse angle β2 (complementary to the negative acute angle β1), the target is head-down, the eyeball direction is downward, and the first target angle α between the face plane L formed by the face of the target and the reference datum plane M is a positive acute angle. At this time, the face orientation of the target is considered to be a vertical downward direction.

Optionally, step S102 may include: if the first target angle is within a preset positive acute angle range of the composition strategy (set according to specific actual application) or the second target angle is within a preset negative acute angle range of the composition strategy (set according to specific actual application) or a preset positive obtuse angle range (set according to actual application), determining that the face orientation of the target matches the preset face orientation with a vertical downward direction in the composition strategy.

Optionally, step S103 may include: if the face orientation of the target matches the preset face orientation with the vertical downward direction in the composition strategy, adjusting the current posture of the photographing device so that a composition direction of an adjusted photographed image is the vertical downward direction, and a position and proportion of a background in the adjusted photographed image match the face orientation of the target. In certain embodiments, the background may include one or more of an upper limb, a lower limb, and/or a foot of the target.

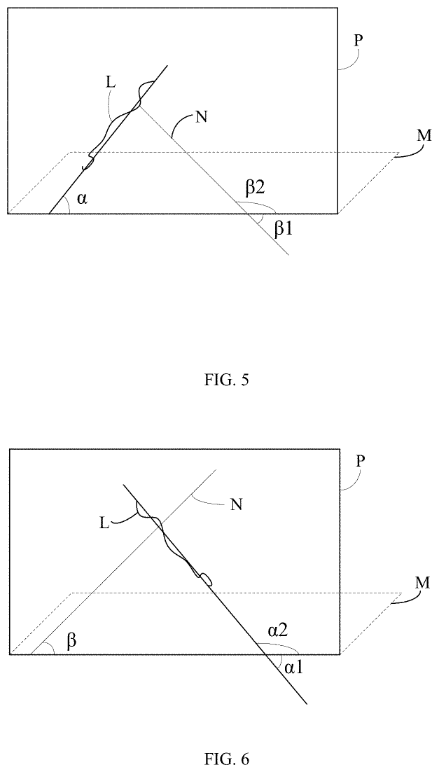

Referring to FIG. 6, FIG. 6 illustrates a schematic diagram of a face orientation in a vertical upward direction in the composition method of the photographing device according to some embodiments of the present disclosure. As shown in FIG. 6, P represents a display screen, for example, a display screen of the photographing device. A first target angle α is an angle between a face plane L formed by the face of the target and a reference datum plane M, and a second target angle β is an angle between an eyeball direction N of the target and the reference datum plane M. The reference datum plane M is a horizontal plane parallel to the ground plane. When the second target angle β is a positive acute angle (the angle above the reference datum plane M is a positive angle, and below the reference datum plane M is a negative angle), it means that the target is head-up, the eyeball direction is upward, and the first target angle α between the face plane L formed by the face of the target and the reference datum plane M is a positive obtuse angle α2 or a negative acute angle α1 (complementary to the positive obtuse angle α2). At this time, the face orientation of the target is considered to be a vertical upward direction.

Optionally, step S102 may include: if the first target angle is within a preset positive obtuse angle range of the composition strategy (set according to specific actual application) or a preset negative acute angle range (set according to specific actual application) or the second target angle is within a preset positive acute angle range of the composition strategy (set according to specific actual application), determining that the face orientation of the target matches the preset face orientation with a vertical upward direction in the composition strategy.

Optionally, step S103 may include: if the face orientation of the target matches the preset face orientation with the vertical upward direction in the composition strategy, adjusting the current posture of the photographing device so that a composition direction of an adjusted photographed image is the vertical upward direction, and a position and proportion of a background in the adjusted captured image match the face orientation of the target. In some embodiments, the background may include one or more of sky and buildings.

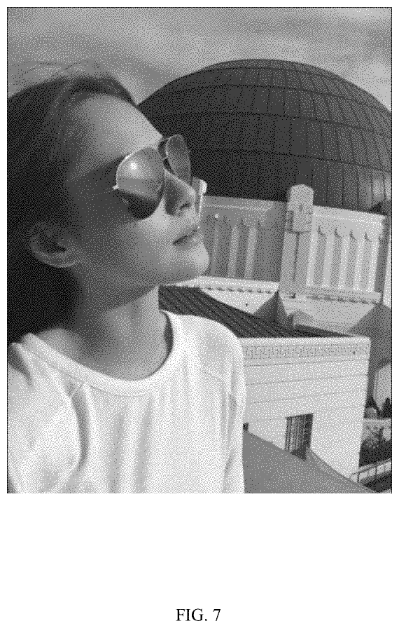

FIG. 7 illustrates a schematic diagram of an image after the face orientation is adjusted in the vertical upward direction in an application of the composition method of the photographing device according to some embodiments of the present disclosure. As shown in FIG. 7, the target person is looking up, i.e., head-up, and the face orientation of the target person is in the vertical upward direction. After adjustment, the target person is located at the left edge of the image, thereby leaving more space in the direction of the face orientation of the target person to show the background: sky, circle architecture and other backgrounds.

In addition to the specific implementation details described above taking the face orientation of the target as an example, the following implementation details may also be provided for other composition strategies.

In some embodiments, after adjusting or maintaining the current posture of the photographing device based upon the matching result, a composition of the photographed image is consistent with a composition model corresponding to the preset face orientation in the composition strategy. That is, in addition to the preset face orientation, the composition strategy also includes a composition model, and the composition model corresponds to the preset face orientation. After adjusting or maintaining the current posture of the photographing device, the composition of the photographed image needs to be consistent with the composition model corresponding to the preset face orientation in the composition strategy. In this way, the composition of the photographed image may be more in line with the composition model in the composition strategy required by the user.

In one embodiment, a proportion difference between the target and the background in an adjusted photographed image is relatively small. In this way, the composition proportion in the adjusted photographed image may be coordinated.

In another embodiment, the face orientation of the target and the background in an adjusted photographed image are roughly symmetrically arranged in the photographed image. In this way, the composition of the adjusted photographed image may be aesthetically pleasing.

The current posture of the photographing device may be adjusted slowly as shown above, so that the adjusted photographed image meets the specific requirements of the composition strategy, or the current posture of the photographing device can be quickly adjusted to a target posture based upon a calculation result through a more accurate calculation method.

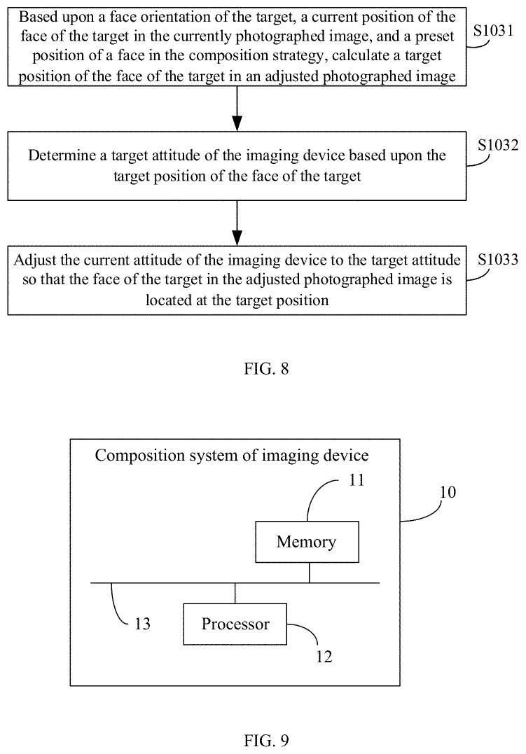

FIG. 8 illustrates a schematic flowchart of a composition method of a photographing device according to some embodiments of the present disclosure. In step S103, adjusting the current posture of the photographing device may include sub-step S1031, sub-step S1032, and sub-step 1033.

In sub-step S1031, based upon a face orientation of the target, a current position of the face of the target in the currently photographed image, and a preset position of a face in the composition strategy, a target position of the face of the target in an adjusted photographed image is calculated.

In sub-step S1032, a target posture of the photographing device is determined based upon the target position of the face of the target.

In sub-step S1033, the current posture of the photographing device is adjusted to the target posture, so that the face of the target in the adjusted photographed image is located at the target position.

In this way, the target posture of the photographing device may be obtained quickly and accurately, the target posture is certain when the photographing device is adjusted, and the photographing device can be quickly adjusted to the target posture.

Optionally, the manner to adjust the photographing device may be implemented by a gimbal or an unmanned aerial vehicle according to two different common scenarios where the application is applied. In some embodiments, for example, in a common ground application scenario, the current posture of the photographing device may be used as a current posture of a gimbal, and the target posture of the photographing device may be used as a target posture of the gimbal. Adjusting the current posture of the photographing device is implemented by adjusting the current posture of the gimbal to the target posture of the gimbal, where the photographing device is provided on the gimbal. In some embodiments, for example, in non-ground application scenarios, the photographing device may be adjusted from the current posture to the target posture by controlling a flying posture of an unmanned aerial vehicle, where the photographing device is provided on the unmanned aerial vehicle.

It is worth noting that various composition changes described above can be used in self-portraits to allow a user to have a smoother composition change when shooting alone. It may also be useful in many other scenarios, such as shooting videos introducing scenic spots.

In addition to dynamic composition, the method may also be used for automatic snapping or taking snapshots. Many users often choose a side face and head-down angle to take pictures for aesthetic reasons, which will also make the photos look more natural and casual.

For common ground application scenarios, after adjusting or maintaining the current posture of the photographing device and obtaining a composition that satisfies the composition strategy, the method may also be used for automatic snapping. For example, for aesthetic reasons, many users often choose a certain angle of side face and head-down for automatic snapping, which makes the photos appear more natural and casual. In this way, the method may further meet the needs of a user and improve the user experience.

Therefore, after step S103, the composition method of the present disclosure may further include, according to snapping strategy, snapping an adjusted or maintained photographed image. The snapping strategy can be pre-set or obtained by voice.

Since a user wants to be as natural as possible when taking selfies, it is also meaningful to take into account the eyeball direction of the user when snapping. For example, when snapping a side face, the eyeball direction of the target is detected. Therefore, snapping after adjusting or maintaining the photographed image may also include acquiring the eyeball direction of the target in the adjusted or maintained photographed image and snapping according to the eyeball direction of the target.

In some embodiments, in order to avoid snapping when the user is peeking at a display screen, the snapping according to the eyeball direction of the target may include snapping when the eyeball direction is inclined to the display screen or forms an oblique angle with the display screen.

Referring to FIG. 9, FIG. 9 illustrates a schematic structural diagram of a composition system of a photographing device according to some embodiments of the present disclosure. It should be noted that the composition system of the photographing device of the present disclosure can execute the steps in the composition method of the photographing device described above. For a detailed description of relevant contents, please refer to the part of the composition method of the photographing device described above, which will not be repeated herein for conciseness.

As shown in FIG. 9, the composition system 10 may include a memory 11 and a processor 12 connected to the memory 11 by a bus 13. The processor 12 may be a micro control unit, a central processing unit, or a digital signal processor, etc. The memory 11 may be a Flash chip, a read-only memory, a magnetic disk, an optical disk, a U disk, or a mobile hard disk, etc.

The memory 11 is configured to store a computer program therein; the processor 12 is configured to execute the computer program and, when executing the computer program, configured to:

acquire a composition factor of a target in an image currently photographed by a photographing device;
match the composition factor of the target with a model composition factor in a composition strategy; and
acquire current posture of the photographing device, and adjust or maintain the current posture of the photographing device based upon the matching result.

Some embodiments of the present disclosure match the composition factor of the target in the currently photographed image of the photographing device with the model composition factor in the composition strategy, and adjust or maintain the current posture of the photographing device based upon the matching result. Since the current posture of the photographing device is adjusted or maintained based upon the matching result between the composition factor of the target in the currently photographed image and the model composition factor in the composition strategy, the composition of the photographed image can be automatically adjusted to avoid interfering with the photographed content and make the photographing process coherent, thereby improving user experience. It can also provide technical support for further flexibly adjusting the composition of the photographed image according to different needs of users.

In some embodiments, the processor, when executing the computer program, is further configured to snap an adjusted or maintained photographed image based upon a snapping strategy.

In some embodiments, the processor, when executing the computer program, is configured to obtain an eyeball direction of the target in an adjusted or maintained photographed image; and snap according to the eyeball direction of the target.

In some embodiments, the processor, when executing the computer program, is configured to snap when the eyeball direction is inclined to a display screen, where the display screen is disposed on the photographing device.

In some embodiments, the model composition factor may include a factor related to a face of the target, and the composition factor of the target include a factor related to the face of the target.

In some embodiments, the processor, when executing the computer program, is configured to acquire a face orientation of the target in the current photographed image of the photographing device.

In some embodiments, the target may include a target person or a target animal.

In some embodiments, the processor, when executing the computer program, is configured to match the face orientation of the target with a preset face orientation in the composition strategy.

In some embodiments, the processor, when executing the computer program, is configured to, if the face orientation of the target partially matches the preset face orientation of the composition strategy, adjust the current posture of the photographing device so that a composition direction of an adjusted photographed image matches a composition direction corresponding to the preset face orientation in the composition strategy; and if the face orientation of the target exactly matches the preset face orientation in the composition strategy, maintain the current posture of the photographing device.

In some embodiments, the processor, when executing the computer program, is configured to, if a first target angle is within a preset vertical angle range of the composition strategy or a second target angle is within a preset parallel angle range of the composition strategy, determine that the face orientation of the target matches the preset face orientation with a horizontal direction in the composition strategy. The first target angle is an angle between a face plane formed by a face of the target and a reference datum plane, and the second target angle is an angle between an eyeball direction of the target and the reference datum plane, and the reference datum plane is a horizontal plane parallel to the ground plane.

In some embodiments, the processor, when executing the computer program, is configured to, if the face orientation of the target matches the preset face orientation with the horizontal direction in the composition strategy, adjust the current posture of the photographing device so that a composition direction of an adjusted captured image is in the horizontal direction and a position and proportion of a background in the adjusted captured image match the face orientation of the target.

In some embodiments, the processor, when executing the computer program, is configured to, if the first target angle is within a preset positive acute angle range of the composition strategy or the second target angle is within a preset negative acute angle range or within a preset positive obtuse angle range of the composition strategy, determine that the face orientation of the target matches the preset face orientation with a vertical downward direction in the composition strategy. The first target angle is an angle between a face plane formed by a face of the target and a reference datum plane, the second target angle is an angle between an eyeball direction of the target and the reference datum plane, and the reference datum plane is a horizontal plane parallel to the ground plane.

In some embodiments, the processor, when executing the computer program, is configured to, if the face orientation of the target matches the preset face orientation with the vertical downward direction in the composition strategy, adjust the current posture of the photographing device so that a composition direction of an adjusted photographed image is in the vertical downward direction and a position and proportion of background in the adjusted photographed image match the face orientation of the target.

In some embodiments, the background may include one or more of an upper limb, a lower limb, or a foot of the target.

In some embodiments, the processor, when executing the computer program, is configured to, if the first target angle is within a preset positive obtuse angle range or with a preset negative acute angle range of the composition strategy or the second target angle is within a preset positive acute angle range of the composition strategy, determine that the face orientation of the target matches the preset face orientation with a vertical upward direction in the composition strategy. The first target angle is an angle between a face plane formed by a face of the target and a reference datum plane, the second target angle is an angle between an eye direction of the target and the reference datum plane, and the reference datum plane is a horizontal plane parallel to the ground plane.

In some embodiments, the processor, when executing the computer program, is configured to, if the face orientation of the target matches the preset face orientation with the vertical upward direction in the composition strategy, adjust the current posture of the photographing device so that a composition direction of an adjusted photographed image is the vertical upward direction and a position and proportion of a background in the adjusted photographed image match the face orientation of the target.

In some embodiments, the background may include one or more of sky or buildings.

In some embodiments, the processor, when executing the computer program, is configured to estimate the face orientation of the target based upon image information of the face of the target.

In some embodiments, the processor, when executing the computer program, is configured to estimate the face orientation of the target based upon an image key point of the face of the target, where the image key point may include one or more of an image key point of a mouth, an image key point of an eye, an image key point of a nose, or an image key point of an eyebrow.

In some embodiments, after adjusting or maintaining the current posture of the photographing device according to the matching result, a composition of the photographed image is consistent with a composition model corresponding to the preset face orientation in the composition strategy.

In some embodiments, in an adjusted photographed image, a proportion difference between the target and the background in the captured image is small.

In some embodiments, the face orientation of the target and the background in an adjusted photographed image are roughly symmetrically arranged in the photographed image.

In some embodiments, the processor, when executing the computer program, is configured to, based upon the face orientation of the target, a current position of the face of the target in the currently photographed image, and a preset position of a face in the composition strategy, calculate a target position of the face of the target in an adjusted photographed image; determine a target posture of the photographing device based upon the target position of the face of the target; and adjust the current posture of the photographing device to the target posture so that the face of the target in the adjusted photographed image is located at the target position.

In some embodiments, the processor, when executing the computer program, is configured to take the current posture of the photographing device as a current posture of a gimbal, take the target posture of the photographing device as a target posture of the gimbal, and adjust the current posture of the gimbal to the target posture of the gimbal, wherein the photographing device is provided on the gimbal.

In some embodiments, the processor, when executing the computer program, is configured to control a flying posture of an unmanned aerial vehicle so that the photographing device is adjusted from the current posture to the target posture, wherein the photographing device is provided on the unmanned aerial vehicle.

In some embodiments, the processor, when executing the computer program, is configured to obtain the composition strategy.

In some embodiments, the processor, when executing the computer program, is configured to set the composition strategy.

In some embodiments, the processor, when executing the computer program, is configured to set the preset face orientation of the composition strategy.

In some embodiments, the processor, when executing the computer program, is configured to directly set the preset face orientation of the composition strategy; or set a face orientation in a known image as the preset face orientation of the composition strategy; or set a current face orientation of a freely rotatable three-dimensional face model as the preset face orientation of the composition strategy; or set a face orientation corresponding to a selected face orientation category as the preset face orientation of the composition strategy, wherein the face orientation category may include one or more of a head-down, a head-up, a tilted-head or a side face.

In some embodiments, the processor, when executing the computer program, is configured to receive voice information and recognize the composition strategy based upon the voice information.

The present disclosure further provides a computer-readable storage medium that stores a computer program, and when the computer program is executed by a processor, the processor is configured to implement any step of the composition method of the photographing device described above. For a detailed description of the relevant content, please refer to the composition method of the photographing device described above, which will not be repeated herein for conciseness.

The computer-readable storage medium may be an internal storage unit of any of the above-mentioned composition systems of the photographing device, such as a hard disk or a memory of the composition system of the photographing device. The computer-readable storage medium may also be an external storage device of the composition system of the photographing device, such as a plug-in hard disk, a smart memory card, a secure digital card, a flash memory card, etc., equipped on the composition system of the photographing device.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program or computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer program or computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Computer program or computer readable program instructions that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

Computer program or computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer program or computer readable program instructions.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The program may be a collection of machine readable instructions and/or data that is stored in non-volatile storage medium and is used to create, manage and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

The embodiments of the present disclosure match the composition factor of the target in the current captured image of the photographing device with the model composition factor in the composition strategy; adjust or maintain the current posture of the photographing device according to the matching result. Since the current posture of the photographing device is adjusted or maintained according to the matching result between the composition factor of the target in the current captured image and the model composition factor in the composition strategy, the composition of the captured image can be automatically adjusted, avoiding interference with the captured content, making the captured process coherent, and improving the user experience. It can also provide technical support for further flexibly adjusting the composition of the captured image according to different needs of users.

Each part of the present disclosure may be implemented by hardware, software, firmware, or a combination thereof. In the above exemplary embodiments, multiple steps or methods may be implemented by hardware or software stored in a memory and executed by a suitable instruction execution system.

The terms used herein are only for the purpose of describing specific embodiments and are not intended to limit of the disclosure. As used in this disclosure and the appended claims, the singular forms “a.” “an,” and “the” are intended to include the plural forms as well, unless the context clearly indicates otherwise. It should also be understood that the term “and/or” as used herein refers to and encompasses any or all possible combinations of one or more associated listed items. Terms such as “connected” or “linked” are not limited to physical or mechanical connections, and may include electrical connections, whether direct or indirect. Phrases such as “a plurality of,” “multiple,” or “several” mean two and more.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A composition method of a photographing device, comprising:
acquiring a composition factor of a target in an image currently photographed by a photographing device;
matching the composition factor of the target with a model composition factor in a composition strategy; and
acquiring current posture of the photographing device, and adjusting or maintaining the current posture of the photographing device based upon result of the matching.

2. The composition method of claim 1, further comprising, after adjusting or maintaining the current posture of the photographing device based upon the result of the matching, snapping the image according to a snapping strategy.

3. The composition method of claim 2, wherein snapping the image according to the snapping strategy comprises:
obtaining an eyeball direction of the target in the image after the adjusting or maintaining the current posture of the photographing device based upon the result of the matching; and
snapping the image according to the eyeball direction of the target.

4. The composition method of claim 3, wherein the snapping the image according to the eyeball direction of the target comprises snapping the image under a condition that the eyeball direction and a display screen of the photographing device are at an oblique angle.

5. The composition method of claim 1, wherein the model composition factor comprises a factor related to a face of the target, and the composition factor of the target comprises a factor related to the face of the target.

6. The composition method of claim 5, wherein the obtaining the composition factor of the target in the image currently photographed by the photographing device comprises acquiring a face orientation of the target in the image currently photographed by the photographing device, wherein the target includes a target person or a target animal.

7. The composition method of claim 6, wherein the matching the composition factor of the target with the model composition factor in the composition strategy comprises matching the face orientation of the target with a preset face orientation in the composition strategy.

8. The composition method of claim 7, wherein the adjusting or maintaining the current posture of the photographing device based upon the result of the matching comprises:
under a condition that the face orientation of the target partially matches the preset face orientation in the composition strategy, adjusting the current posture of the photographing device so that a composition direction of the image after the adjusting matches a composition direction corresponding to the preset face orientation in the composition strategy; or
under a condition that the face orientation of the target exactly matches the preset face orientation in the composition strategy, maintaining the current posture of the photographing device.

9. The composition method according to claim 7, wherein the matching the face orientation of the target with the preset face orientation in the composition strategy comprises:
under a condition that a first target angle is within a preset vertical angle range of the composition strategy, or under a condition that a second target angle is within a preset parallel angle range of the composition strategy, determining that the face orientation of the target matches the preset face orientation with a horizontal direction in the composition strategy,
wherein the first target angle is an angle between a face plane formed by the face of the target and a reference datum plane, the second target angle is an angle between an eyeball direction of the target and the reference datum plane, and the reference datum plane is a horizontal plane parallel to a ground plane.

10. The composition method of claim 9, wherein the adjusting the current posture of the photographing device under the condition that the face orientation of the target matches the preset face orientation in the composition strategy comprises:
under a condition that the face orientation of the target matches the preset face orientation with the horizontal direction in the composition strategy, adjusting the current posture of the photographing device so that a composition direction of the image after the adjusting is in the horizontal direction and a position and proportion of a background in the image match the face orientation of the target.

11. The composition method of claim 7, wherein the matching the face orientation of the target with the preset face orientation in the composition strategy comprises:
under a condition that a first target angle is within a preset positive acute angle range of the composition strategy or a second target angle is within a preset negative acute angle range or a preset positive obtuse angle range of the composition strategy, determining that the face orientation of the target matches the preset face orientation with a vertical downward direction in the composition strategy,
where the first target angle is an angle between a face plane formed by the face of the target and a reference datum plane, the second target angle is an angle between an eyeball direction of the target and the reference datum plane, and the reference datum plane is a horizontal plane parallel to a ground plane.

12. The composition method of claim 11, wherein the adjusting the current posture of the photographing device under the condition that the face orientation of the target matches the preset face orientation in the composition strategy comprises:
under a condition that the face orientation of the target matches the preset face orientation with the vertical downward direction in the composition strategy, adjusting the current posture of the photographing device so that a composition direction of the image after the adjusting is in the vertical downward direction and a position and proportion of a background in the image matches the face orientation of the target.

13. The method according to claim 7, wherein the matching the face orientation of the target with the preset face orientation in the composition strategy comprises:
under a condition that a first target angle is within a preset positive obtuse angle range or a preset negative acute angle range of the composition strategy, or under a condition that a second target angle is within a preset positive acute angle range of the composition strategy, determining that the face orientation of the target matches the preset face orientation with a vertical upward direction in the composition strategy,
wherein the first target angle is an angle between a face plane formed by the face of the target and a reference datum plane, the second target angle is an angle between an eyeball direction of the target and the reference datum plane, and the reference datum plane is a horizontal plane parallel to a ground plane.

14. The composition method of claim 13, wherein the adjusting the current posture of the photographing device under the condition that the face orientation of the target matches the preset face orientation in the composition strategy comprises:
under a condition that the face orientation of the target matches the preset face orientation with the vertical upward direction in the composition strategy, adjusting the current posture of the photographing device so that a composition direction of the image after the adjusting is in the vertical upward direction and a position and proportion of a background in the image match the face orientation of the target.

15. The composition method of claim 6, wherein the acquiring the face orientation of the target in the image currently photographed by the photographing device comprises:
estimating the face orientation of the target based upon image information of the face of the target.

16. The composition method of claim 15, wherein the estimating the face orientation of the target based upon the image information of the face of the target comprises:
estimating the face orientation of the target based upon an image key point of the face of the target,
wherein the image key point includes one or more of an image key point of a mouth, an image key point of an eye, an image key point of a nose, or an image key point of an eyebrow.

17. The composition method of claim 1, wherein before matching the composition factor of the target with the model composition factor in the composition strategy, the composition method further comprises:
setting a preset face orientation of a composition strategy; and
acquiring the composition strategy.

18. The composition method of claim 17, wherein the setting the preset face orientation of the composition strategy comprises:
directly setting the preset face orientation of the composition strategy;
setting a face orientation in a known image as the preset face orientation of the composition strategy;
setting a current face orientation of a freely rotatable three-dimensional face model as the preset face orientation of the composition strategy; or
setting a face orientation corresponding to a selected face orientation category as the preset face orientation of the composition strategy, wherein the face orientation category includes one or more of a head-down, a head-up, a tilted-head, or a side face.

19. The composition method of claim 17, wherein the acquiring the composition strategy comprises:
receiving voice information; and
recognizing the composition strategy based upon the voice information.

20. A composition system for a photographing device, comprising a memory and a processor, the memory configured to store a computer program, and the processor configured to execute the computer program stored in the memory and, when executing the computer program, configured to:
acquire a composition factor of a target in an image currently photographed by a photographing device;
match the composition factor of the target with a model composition factor in a composition strategy; and
acquire current posture of the photographing device, and adjust or maintain the current posture of the photographing device based upon result of the matching.
